(19) United States
(12) Patent Application Publication
(10) Pub. No.: US 2019/0108355 A1
(43) Pub. Date: Apr. 11, 2019

(54) SYSTEMS AND METHODS FOR IDENTIFYING POTENTIAL MISUSE OR EXFILTRATION OF DATA

(71) Applicant: Digital Guardian, Inc., Waltham, MA (US)

(72) Inventor: Dwayne A. Carson, Mendon, MA (US)

(21) Appl. No.: 15/728,137

(22) Filed: Oct. 9, 2017

(51) Int. Cl. G06F 21/62

(52) U.S. Cl. CPC G06F 21/6209

(57) ABSTRACT

Provided herein are systems and methods for preventing or controlling data movement. A learning engine may detect capabilities of a computing environment for allowing data access or transfer, and activities relating to data access or transfer from the computing environment. Data assets of the computing environment that are protected may be identified, according to metadata of the data assets. The learning engine may, according to the identified data assets and at least one of the detected capabilities or activities, determine a situation within the computing environment that represents potential or actual exfiltration of one of the identified data assets. A rule engine may perform an action to prevent or control the potential or actual data movement of the one of the identified data assets, responsive to applying one or more rules to the determined situation.

### TECHNICAL FIELD

The present application relates generally to systems and methods for data leakage/loss prevention, including but not limited to systems and methods for preventing or controlling data movement.

### BACKGROUND

In a computing environment, certain applications may attempt to access mission-critical data assets. The attempts to access may be connected to various function calls of these applications, and may be aimed at exfiltrating the mission-critical data assets, thereby compromising the security of the computing environment and/or the data assets themselves. Some of these attempts at accessing the mission-critical data assets may be unauthorized. Present techniques of preventing unauthorized access and transfer of mission-critical data assets may be on static, predicate logic basis.

### SUMMARY

Described herein are systems and methods for preventing or controlling misuse of data or file (e.g., exfiltration, opening, storing, downloading, uploading, movement). To protect against unauthorized exfiltration of data assets, the present systems and methods may execute preventive or counter measures based on identifying potentially compromising situations on a computing environment using machine learning techniques. Illustrative applications for the systems and methods may include, but not limited to using an exfiltration control system executing in the computing environment to detect, manage, and/or prevent exfiltration by applications (e.g., web browsers, electronic mail applications, document processing applications, facsimile or printing applications, a transfer applications, and cloud storage applications), background system services, or other processes of the computing environment (e.g., copy and paste operation, screenshot acquisition, and connection of removable computer storage).

In some embodiments, an exfiltration controller executing in the computing environment may identify data assets through the use of associated metadata. Such data assets may include document files, data strings (e.g., personal or security identifiers), images, audio, or any other file or data residing in the computing environment. The data assets that are to be protected may be identified through a combination of information context and content inspection. Information context may include an address, a file/data type, date and/or time of creation or update, location, source, and/or a file/data owner/author, among others, of the data asset. Content inspection may include a determination as to whether the data asset contains sensitive or classified information. The exfiltration controller may also determine a sensitivity level for the data asset. The determination of the sensitivity level may allow for high-fidelity risk assessment relative to a potential attack on the computing environment. Based on the sensitivity level of the data asset, the exfiltration controller may also deploy resiliency mechanisms with granularity, with greater protections for more sensitive data assets.

The exfiltration controller may monitor user interactions and application behavior in relation to the data assets to be protected. Using machine learning techniques, the exfiltration controller may identify a set of user interaction and application behavior that correlate with or are strongly associated with attempts to transfer the data asset to an unpermitted destination via a network or via an input/output device of the computing environment. The exfiltration controller may predict and detect egress of data assets at an end point (e.g., the network or input/output device) using multiple neural networks. For each application running in the computing environment, the exfiltration controller may collect or monitor various characteristics and/or metadata of the graphical user interface of the application presented to the user, application programming interface (API) function calls made by the application (e.g., that is a system service or user application), and input/output device interaction by the user with respect to the application, among others. On the graphical user interface of the application, the exfiltration controller may apply pattern recognition techniques to identify control elements (visible and non-visible, such as via their associated metadata, identifiers or text) to determine capabilities and/or functionalities of the graphical user interface. Each control element of the graphical user interface may be determined to be associated with particular function calls by the application itself and/or input/output device interaction by the user, and vice-versa.

As more information regarding the application with respect to the data assets to be protected is aggregated or collected, the exfiltration controller may feed the information to one of the neural networks upon an occurrence of a triggering event. The triggering event may include an expiration of a predefined time interval, a start time, a user action, a detection of the application or its installation in the computing environment, a detection of an attempt to read the data asset, a detection of an attempt to copy the data over the network, among others. Once trained, the exfiltration controller may determine whether the situation of the computing environment correlates to a potential or an actual egress of protected data assets. Upon recognizing situations on the computing environment that may actually or potentially lead to unauthorized transfer of data assets, the exfiltration controller may apply one or more rules specified by a policy. The one or more rules may include displaying a prompt warning the user of the computing device and/or blocking the unauthorized exfiltration of data assets, among others. The one or more rules applied may also depend on the data asset, an account corresponding to the user signed into the computing environment, and/or identity of the user, for instance.

At least one aspect of the present disclosure is directed to a system for preventing or controlling data movement. The system may include a learning engine executing on one or more processors. The learning engine may detect capabilities of a computing environment for allowing data access or transfer, and activities relating to data access or transfer from the computing environment. The learning engine may determine, according to data assets of the computing environment that are identified to be protected, and at least one of the detected capabilities or activities, a situation within the computing environment that represents potential or actual misuse or exfiltration of one of the identified data assets. The data assets that are to be protected may be identified according to metadata of the data assets. The system may include a rule engine executing on the one or more processors. The rule engine may perform an action to prevent or control the potential or actual data movement of the one of the identified data assets, responsive to applying one or more rules to the determined situation.

In some embodiments, the system may include training data for use by the learning engine to recognize application or user behavior indicative of potential or actual data movement. In some embodiments, the learning engine may detect the capabilities or the activities by monitoring or detecting one or more of: graphical user interface (GUI) controls available to a user control selection by the user, application programming interface (API) calls, files accessed, data accessed or communicated over a network, data transferred or saved to a user storage device, or activity using an input/output (I/O) device.

In some embodiments, the learning engine may identify a first data asset that is protected, by monitoring or identifying at least one of: a residing location of the first data asset, an owner of the first data asset, a type of the first data asset, or whether some or all of the first data asset includes classified or sensitive data. In some embodiments, the computing environment may include at least one of a web browser, an application, a background system service, or an input/output (I/O) device. In some embodiments, the application may include a cloud-synchronization application, an electronic-mail application, a document processing or rendering application, a data transfer or copying application, or a facsimile or printing application.

In some embodiments, the learning engine may detect the capabilities or the activities by detecting meta-data, words or phrases associated with application interfaces or GUI controls indicative of means of data egress from the computing environment. In some embodiments, the learning engine may determine the situation within the computing environment that represents potential or actual misuse (e.g., exfiltration) of the one of the identified data assets, by relating the detected words or phrases in the application interfaces, to a user action via one or more corresponding application interfaces.

In some embodiments, the learning engine may determine whether there is a situation within the computing environment that represents potential or actual misuse or exfiltration of one or more of the identified data assets, responsive to a triggering event. In some embodiments, the action to prevent or control the potential or actual data movement may include at least one of: warning or blocking a user against data movement of the one of the identified data assets, or blocking data movement of the one of the identified data assets by an application, or sending a prompt or warning to a user while allowing the data to be accessed or transferred.

At least one aspect of the present disclosure is directed to a method of preventing or controlling data movement. A learning engine executing on one or more processors may detect capabilities of a computing environment for allowing data access or transfer, and activities relating to data access or transfer from the computing environment. Data assets of the computing environment that are protected may be identified, according to metadata of the data assets. The learning engine may, according to the identified data assets and at least one of the detected capabilities or activities. The learning engine may determine a situation within the computing environment that represents potential or actual misuse (e.g., exfiltration) of one of the identified data assets. A rule engine executing on the one or more processors may perform an action to prevent or control the potential or actual data movement of the one of the identified data assets, responsive to applying one or more rules to the determined situation.

In some embodiments, training data may be provided for use by the learning engine to recognize application or user behavior indicative of potential or actual data movement. In some embodiments, detecting the capabilities or the activities may include monitoring or detecting one or more of: graphical user interface (GUI) controls available to a user, control selection by the user, application programming interface (API) calls, files accessed, data communicated over a network, or activity using an input/output (I/O) device.

In some embodiments, a first data asset that is protected may be identified, by monitoring or identifying at least one of: a residing location of the first data asset, an owner of the first data asset, a type of the first data asset, or whether part or all of the first data asset comprises classified or sensitive data. In some embodiments, the computing environment may include at least one of a web browser, an application, background system service, or an input/output (I/O) device. In some embodiments, the application may include a cloud-synchronization application, an electronic-mail application, a document processing or rendering application, a data transfer or copying application, or a facsimile or printing application.

In some embodiments, detecting the capabilities and/or the activities may include detecting words or phrases in application interfaces indicative of means of data egress from the computing environment. In some embodiments, determining the situation within the computing environment that represents potential or actual misuse of the one of the identified data assets, may include relating the detected words or phrases in the application interfaces, to a user action via one or more corresponding application interfaces.

In some embodiments, the learning engine may determine whether there is a situation within the computing environment that represents potential or actual misuse or exfiltration of one or more of the identified data assets, responsive to a triggering event. In some embodiments, the action to prevent or control the potential or actual data movement may include at least one of: warning or blocking a user against data movement of the one of the identified data assets, or blocking data movement of the one of the identified data assets by an application.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

It should be understood that the drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is a block diagram depicting an embodiment of a network environment comprising client devices in communication with server devices;

FIG. 1B is a block diagram depicting a cloud computing environment comprising client devices in communication with a cloud service provider;

FIGS. 1C and 1D are block diagrams depicting embodiments of computing devices useful in connection with the methods and systems described herein;

FIG. 2 is a block diagram depicting an example embodiment of a system for preventing or controlling data movement; and

FIG. 3 is a flow diagram depicting an example embodiment of a method of preventing or controlling data movement.

The features and advantages of the concepts disclosed herein will become more apparent from the detailed description set forth below when taken in conjunction with the drawings.

### DETAILED DESCRIPTION

Following below are more detailed descriptions of various concepts related to, and embodiments of, inventive systems and methods for preventing or controlling data movement. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes a network environment and computing environment which may be useful for practicing various computing related embodiments described herein.

Section B describes systems and methods for preventing or controlling data movement.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

### A. Computing and Network Environment

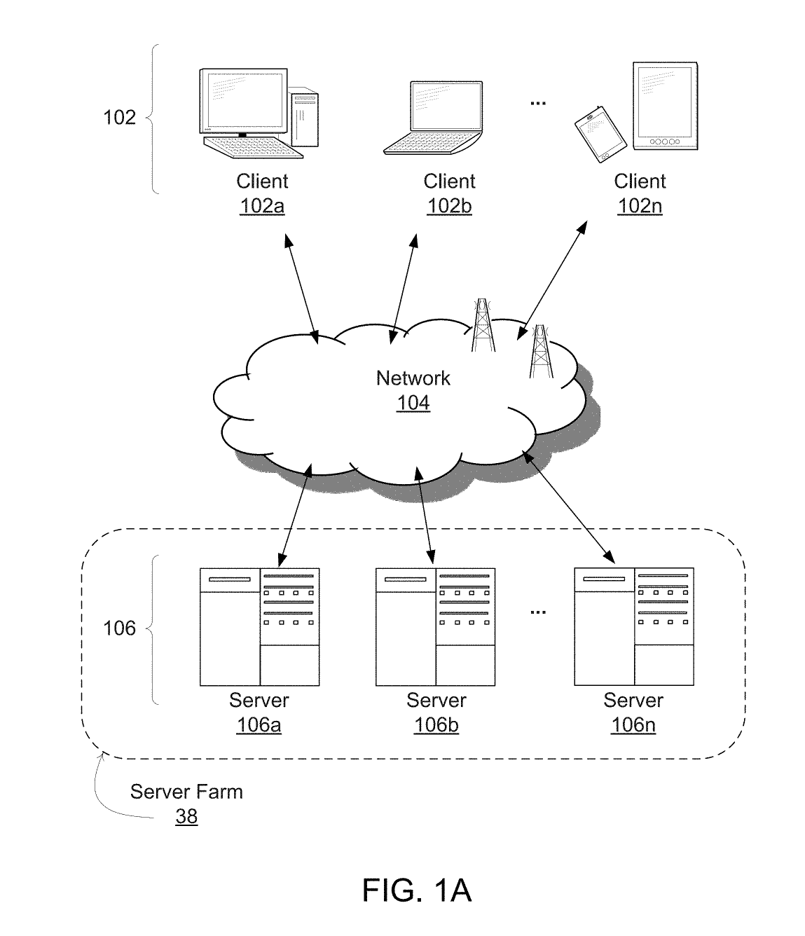

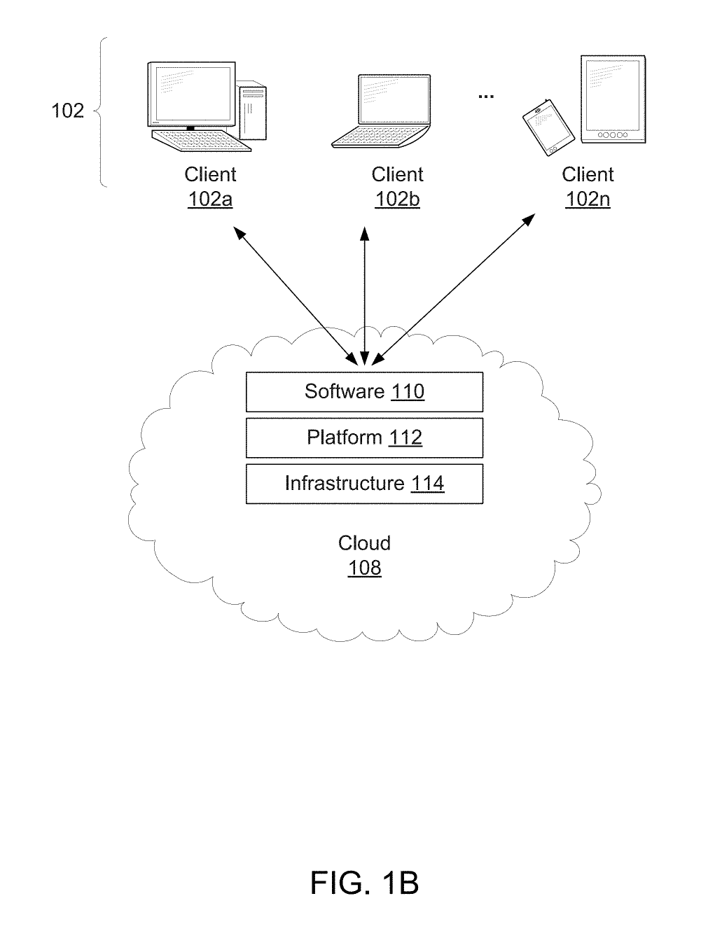

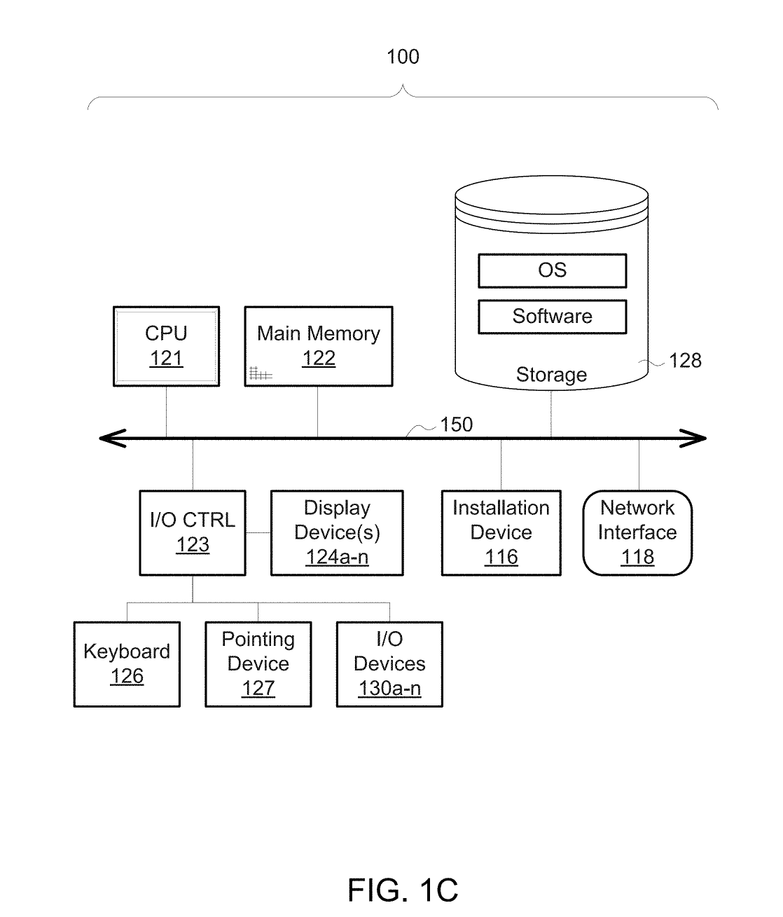

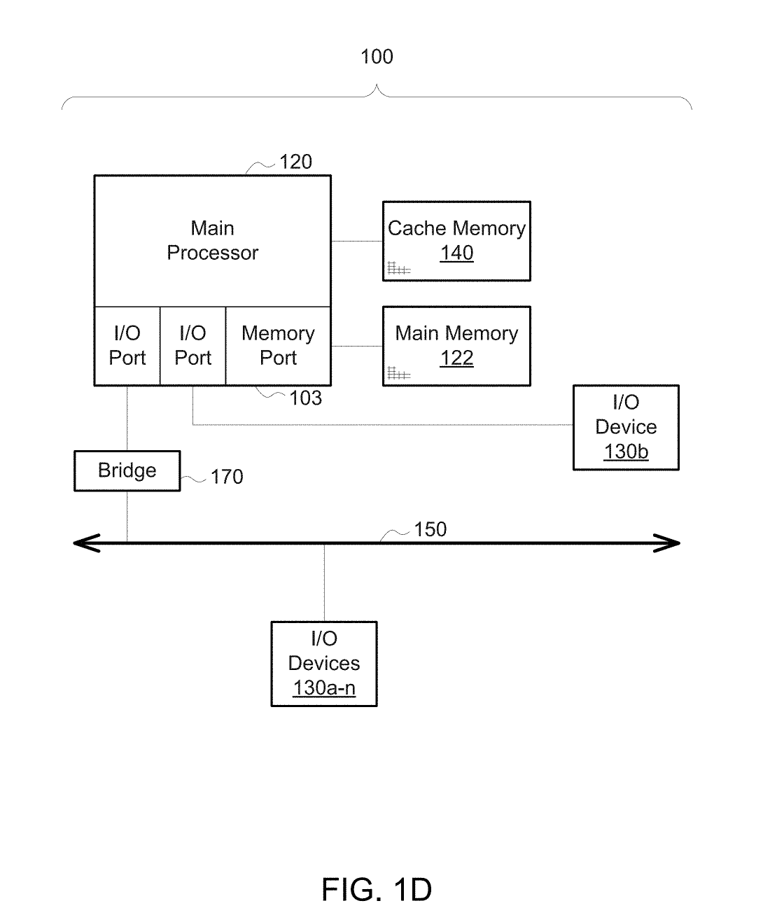

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the illustrated exploring network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, NFC, RFID Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network, which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualized physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, and/or software 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via an I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call. In some embodiments, the communication device 102 is a wearable mobile computing device including but not limited to Google Glass and Samsung Gear.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Preventing or Controlling Misuse or Exfiltration of Data

Described herein are systems and methods for preventing or controlling misuse of data or file (e.g., exfiltration, opening, storing, downloading, uploading, movement). To protect against unauthorized exfiltration of data assets, the present systems and methods may execute preventive or counter measures based on identifying potentially compromising situations on a computing environment using machine learning techniques. Illustrative applications for the systems and methods may include, but not limited to using an exfiltration control system executing in the computing environment to detect, manage, and/or prevent exfiltration by applications (e.g., web browsers, electronic mail applications, document processing applications, facsimile or printing applications, a transfer applications, and cloud storage applications), background system services, or other processes of the computing environment (e.g., copy and paste operation, screenshot acquisition, and connection of removable computer storage).

In some embodiments, an exfiltration controller executing in the computing environment may identify data assets through the use of associated metadata. Such data assets may include document files, data strings (e.g., personal or security identifiers), images, audio, or any other file or data residing in the computing environment. The data assets that are to be protected may be identified through a combination of information context and content inspection. Information context may include an address, a file/data type, date and/or time of creation or update, location, source, and/or a file/data owner/author, among others, of the data asset. Content inspection may include a determination as to whether the data asset contains sensitive or classified information. The exfiltration controller may also determine a sensitivity level for the data asset. The determination of the sensitivity level may allow for high-fidelity risk assessment relative to a potential attack on the computing environment. Based on the sensitivity level of the data asset, the exfiltration controller may also deploy resiliency mechanisms with granularity, with greater protections for more sensitive data assets.

The exfiltration controller may monitor user interactions and application behavior in relation to the data assets to be protected. Using machine learning techniques, the exfiltration controller may identify a set of user interaction and application behavior that correlate with or are strongly associated with attempts to transfer the data asset to an unpermitted destination via a network or via an input/output device of the computing environment. The exfiltration controller may predict and detect egress of data assets at an end point (e.g., the network or input/output device) using multiple neural networks. For each application running in the computing environment, the exfiltration controller may collect or monitor various characteristics and/or metadata of the graphical user interface of the application presented to the user, application programming interface (API) function calls made by the application (e.g., that is a system service or user application), and input/output device interaction by the user with respect to the application, among others. On the graphical user interface of the application, the exfiltration controller may apply pattern recognition techniques to identify control elements (visible and non-visible, such as via their associated metadata, identifiers or text) to determine capabilities and/or functionalities of the graphical user interface. Each control element of the graphical user interface may be determined to be associated with particular function calls by the application itself and/or input/output device interaction by the user, and vice-versa.

As more information regarding the application with respect to the data assets to be protected is aggregated or collected, the exfiltration controller may feed the information to one of the neural networks upon an occurrence of a triggering event. The triggering event may include an expiration of a predefined time interval, a start time, a user action, a detection of the application or its installation in the computing environment, a detection of an attempt to read the data asset, a detection of an attempt to copy the data over the network, among others. Once trained, the exfiltration controller may determine whether the situation of the computing environment correlates to a potential or an actual egress of protected data assets. Upon recognizing situations on the computing environment that may actually or potentially lead to unauthorized transfer of data assets, the exfiltration controller may apply one or more rules specified by a policy. The one or more rules may include displaying a prompt warning the user of the computing device and/or blocking the unauthorized exfiltration of data assets, among others. The one or more rules applied may also depend on the data asset, an account corresponding to the user signed into the computing environment, and/or identity of the user, for instance.

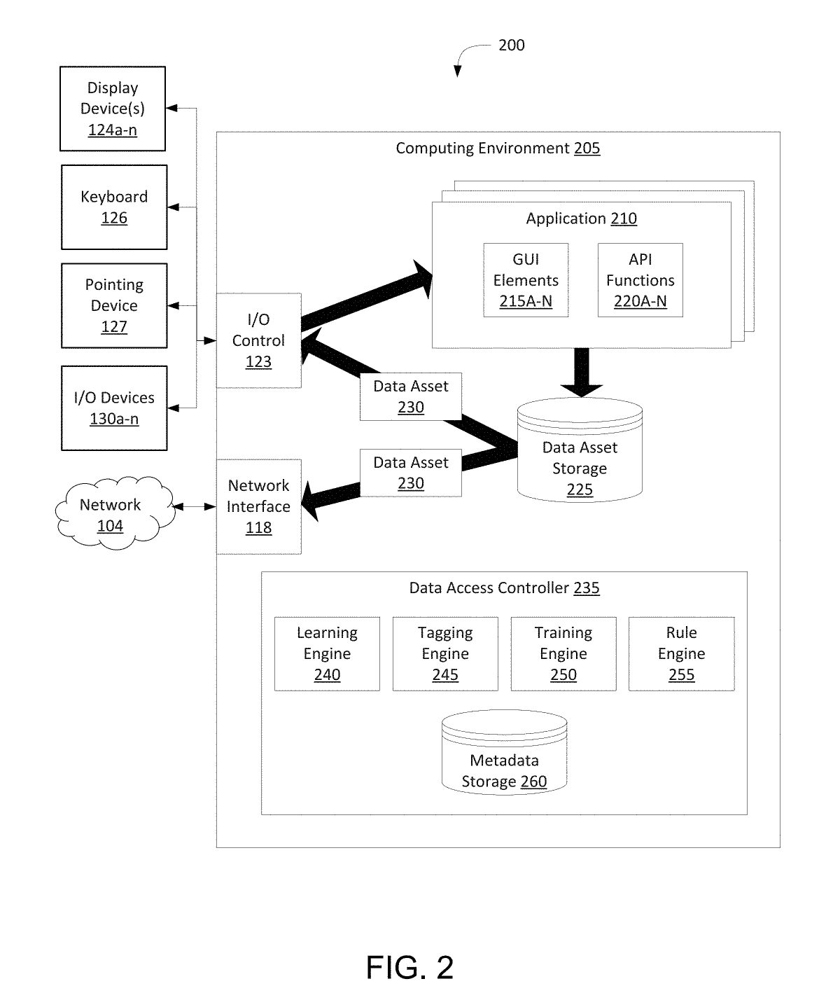

Referring now to FIG. 2, an embodiment of a system 200 for preventing or controlling data movement or misuse is depicted. In brief overview, the system 200 may include a computing environment 205. The computing environment 205 may correspond to the computing device 100 as described in FIGS. 1C and 1D, and may include an application 210, data asset storage 225, and an data access controller 235 interacting with the network interface 118 and I/O control 123. The application 210 may comprise any type or form of software, script or program, such as a background system service or program. In some embodiments, the application 210 may include one or more graphical user interface (GUI) elements 215a-n and one or more application programming interface (API) functions 220a-n, among others. The data asset storage 225 may include or store one or more data assets 230. The data access controller 235 may include a learning engine 240, a tagging engine 245, a training engine 250 (a source or storage for training data), a rule engine 255, and/or metadata storage 260.

Each of the above-mentioned elements or entities (e.g., application 210 and its components, data asset storage 225, data assets 230, and data access controller 235 and its components) is implemented in hardware, or a combination of hardware and software, in one or more embodiments. For instance, each of these elements or entities could include any application, program, library, script, task, service, process or any type and form of executable instructions executing on hardware of the system, in one or more embodiments. The hardware includes circuitry such as one or more processors, for example, as described above in connection with FIGS. 1A-1D, in some embodiments, as detailed in section A.

In an attempt to access and/or transfer data from the computing environment 205, the application 210 may perform an unauthorized or potentially risky access of the data asset storage 225. The application 210 may be any type of executable running on the computing environment 205, such as a cloud-synchronization application, an electronic mail application, a word processor application, a document-rendering application, a data transfer application, a data copying application, a facsimile application, or a printing application, among others. The attempt to perform the unauthorized access by the application 210 may be triggered by any selection of the GUI elements 215a-n, an invocation of an API function call 220a-n, or otherwise another action/routine directly or indirectly initiated by the application 210 or by multiple applications. In some embodiments, the invocation of the API function calls 220a-n may be associated with the selection of the GUI element 215a-n, or unassociated with any GUI element.

The data asset storage 225 may include one or more data assets 230. The data asset storage 225 may correspond to one or more directories maintaining, storing or otherwise including the data assets 230. Each data asset 230 may correspond to one or more files (e.g., document files, spreadsheet files, electronic emails, database files, image files, audio files, video files) stored within or otherwise accessible from the computing environment 205. Each data asset 230 may be stored on the storage 128, main memory 122, cache memory 140, I/O devices 130a-n, or any other computer readable storage medium connected to or within the computing environment 205. Each data asset 230 of the data asset storage 225 may have one or more attributes. Each data asset 230 may be associated with a residing location. The residing location may be a file pathname that may indicate a drive letter, volume, server name, root directory, sub-directory, file name, and/or extension among others. Each data asset 230 may be associated with an owner indicated using a user identifier (e.g., username, screenname, account identifier, electronic mail address) for example. Each data asset 230 may be associated with a source or author. Each data asset 230 may be associated with a file type. Each data asset 230 may indicate whether part or all the content is classified or sensitive. Each data asset 230 may be associated with a file system permission specifying ability to read, write, and execute for different applications 210 and users of the computing environment 205.

By accessing the data asset storage 225, the application 210 may also attempt an unpermitted transfer of data asset 230 from the computing environment 205. The application 210 may attempt to transfer the data asset 230 to the network interface 118 to transmit the data asset 230 via the network 104 to another computing device. The application 210 may attempt to transfer the data asset 230 to the I/O control 123 to output the data asset 230 on one of the I/O devices 130a-n, the display devices 124a-n, or another computer readable storage medium connected to the computing environment 205. An I/O device may include for instance a printer or fax machine, a flash drive or other peripheral/storage device that can receive files, an I/O interface to send files to a network or another device, or a user-input device (e.g., keyboard with print key) that can be used to perform or facilitate data movement. In some embodiments, the computing environment 205 may be used to transfer data from/via the network 104 to one or more I/O devices (e.g., an illegal or restricted destination or storage location). The I/O device can refer to software and/or hardware, for instance software that does the data exfiltration or movement (e.g., the web browser, the application), and/or the destination of the exfiltrated data.

The selection of the GUI elements 215a-n, the invocation of an API function calls 220a-n, or otherwise another routine/action of the application 210 may specify whether the data asset 230 is to be exfiltrated via the network interface 118 or the I/O control 123. The data access controller 235 may detect the attempts by the application 210 to access the data asset storage 225 and may prevent the transfer of the data asset 230 from or through the computing environment 205. The functionalities of the data access controller 235 are detailed herein below.

To prevent unpermitted exfiltration of data assets 230 from the data asset storage 225, the learning engine 240 of the data access controller 235 may detect capabilities of the computing environment 205 for allowing data access or transfer. The learning engine 240 may identify the capabilities of the computing environment 205 for allowing access to the data asset storage 225 and for transfer of the data assets 230. The learning engine 240 may identify capabilities of the application 210 in accessing the data asset storage 225 or transferring the data assets 230. In some embodiments, the learning engine 240 may identify the GUI elements 215a-n available to user control selection. In some embodiments, the learning engine 240 may identify API function calls 220a-n available for invocation by the application 210.

In some embodiments, the learning engine 240 may identify GUI elements 215a-n of the application 210 available to user control selection by the user of the application 205. To identify the GUI elements 215a-n, the learning engine 240 may access one or more display drivers, document object models, object identification tables, meta-data of the application or the application's GUI, etc. In some embodiments, the learning engine 240 may access or use built-in application programming interfaces (APIs), such as accessibility interfaces or accessibility callbacks. In some embodiments, to identify the GUI elements 215a-n, the learning engine 240 may acquire a screenshot and/or other information of the rendering of the application 205. The learning engine 240 may then apply image recognition algorithms (e.g., object recognition) to the screenshot of the rendering of the application 205 to identify the GUI elements 215a-n. Using optical character recognition (OCR) or other image recognition algorithms, the learning engine 240 may identify text on each detected GUI element 215a-n. The learning engine 240 may compare the recognized text on each detected GUI element 215a-n (and/or any available meta-data) to a predefined list of meta-data, words, or phrases indicative of data egress from the computing environment 205. Examples of meta-data, words, or phrases indicative of data egress may include “Send”, “Forward”, “Transfer”, “Print”, “Attach”, “Upload”, and “Copy Over”, among others. In some embodiments, the learning engine 240 may apply natural language processing techniques (e.g., lexical semantics, parsing, semantic-search knowledge database) to the recognized text on each GUI element 215a-n to determine whether the text includes meta-data, words, or phrases indicative of data egress from the computing environment 205. Based on the recognized text on each detected GUI element 215a-n, the learning engine 240 may identify the capabilities of the application 210 in accessing the data asset storage 225 or transferring the data assets 230.

In some embodiments, the learning engine 240 may identify API function calls 220a-n available to or used by the application 210. The learning engine 240 may identify the application 210 and one or more attributes of the application 210, such as a name and a type, among others. Using the identified application 210 and the one or more attributes, the learning engine 240 may for instance identify a predefined specification for the application 210 (e.g., stored at the data access controller 235). The predefined specification may specify which API function calls 220a-n are available to the application 210. The predefined specification may indicate the capabilities of each of the API function calls 220a-to access the data storage 225 and/or to transfer the data assets 230. In some embodiments, the predefined specification may indicate whether the API function call 220a-n is to transfer data assets 230 via the network interface 118 or the I/O control 123. The predefined specification may also indicate types (e.g., file types) of the data assets 230 that the identified application 210 may read, write, or execute. From the predefined list of applications, the learning engine 240 may determine which API function calls 220a-n are available to or used by the application 210. Based on the identified API function calls 220a-n, the learning engine 240 may identify the capabilities of the application 210 in accessing the data asset storage 225 or transferring the data assets 230.

In addition, the learning engine 240 may detect activities relating to data access or transfer from the computing environment 205. The learning engine 240 may detect the activities by the application 205 in relation to access of the data asset storage 225 or transfer of the data assets 230. The learning engine 240 may identify the activities within the computing environment 205 related to access to the data asset storage 225 and for transfer of the data assets 230. In some embodiments, the learning engine 240 may monitor for or detect user interactions with the GUI elements 215a-n. In some embodiments, the learning engine 240 may intercept or acquire information or images about the rendering of the application 210. The learning engine 240 may for instance apply image recognition techniques (e.g., object recognition or motion detection) to screenshots of the rendering of the application 210 to detect user interactions (e.g., click, hover over) with the GUI elements 215a-n. The learning engine 240 may monitor for or detect invocations of API function calls 220a-n. To detect invocations of API function calls 220a-n, the learning engine 240 may intercept function calls 220a-n for instance using hooking techniques (e.g., insertion of a hooking function into the function call 220a-n, DLL injection, import address table hooking) or interception/listening techniques. In some embodiments, the learning engine 240 may monitor or detect use of the I/O control 123. I/O control may refer to or comprise an I/O mechanism or interface to initiate, control, manage, enable and/or monitor or detect activity with any input or output devices. In some embodiments, the learning engine 240 may monitor or detect activity corresponding to user interaction on the I/O devices 130a-n, the keyboard 126, the pointing device 127 the display devices 124a-n, or another computer readable storage medium connected to the computing environment 205 via the I/O control 123. To detect use of the I/O control 123 or on any of the devices connected thereto, the learning engine 240 may monitor for presence of data passed from and to the I/O control 123. The learning engine 240 may monitor or detect use of the network interface 118. In detecting use of the network interface 118, the learning engine 240 may monitor for presence of data passed from and to the network interface 118 connected to the network 104.

The learning engine 240 may interrelate among the various activities relating to data access or transfer from the computing environment 205. The interrelation among the various activities may be based on occurrence of the activities within a predetermined time period, or according to a specific sequence. In some embodiments, the learning engine 240 may relate the detected words or phrases on one of the GUI elements 215a-n with the invocation of the API function call 220a-n, and vice-versa. For example, if one of the GUI elements 215a-n includes the words “Save As” and subsequently detects an invocation of the API function call 220a-n corresponding to a save function, the learning engine 240 may relate the two activities. In some embodiments, the learning engine 240 may relate the detected words or phrases on one of the GUI elements 215a-n with the activity corresponding to user interaction on the I/O devices 130a-n, the keyboard 126, the pointing device 127 the display devices 124a-n, or another computer readable storage medium connected to the computing environment 205 via the I/O control 123, and vice-versa. For example, if one of the GUI elements 215a-n includes or has meta-data associated with the words “Print” and the learning engine subsequently detects a user of a printer, the learning engine 240 may relate the two. In some embodiments, the learning engine 240 may relate the detected words or phrases on one of the GUI elements 215a-n with the use of the network interface 118, and vice-versa. For example, if one of the GUI elements 215a-n includes the words “Forward” and subsequently detects use of the network interface 118, the learning engine 240 may relate the two. In some embodiments, the learning engine 240 may relate the activity on the I/O control 123 with the detection of the API function call 220a-n, and vice-versa. For example, if a click is detected on the pointing device 125 and then subsequently detects the invocation of an API function call 220a-n, the learning engine 240 may relate the two. In some embodiments, the learning engine 240 may relate the activity on the I/O control 123 with the use of the network interface 118, and vice-versa.

To identify which of the data assets 230 that are to be protected, the tagging engine 245 of the data access controller 235 may set or modify meta-data of the corresponding data asset 230 accordingly. In some embodiments, the functionalities of the tagging engine 245 may be performed by the learning engine 240 or any other component of the computing environment 205. The meta-data of the corresponding data asset 230 may be part of the file attributes of the one or more files for the respective data asset 230. In some embodiments, the meta-data (or tags) may be placed in file attributes or in a data stream of the file or a local or remote database (e.g., the metadata storage 260). In some embodiments, the meta-data may be placed in a shadow file. The shadow file may be located in a subdirectory of a location (or directory) of the corresponding or original data asset 230. The tagging engine 245 may set the meta-data of the data asset 230 to include a protection indicator for instance. The protection indicator may specify whether the accessing and/or transfer of the data asset 230 is to be protected by the data access controller 235. In some embodiments, the protection indicator may also specify a level of protection for the data asset 230. The level of protection may correspond to what actions are to be taken by the data access controller 235 to prevent access or transfer of the data asset 230 to be protected from the computing environment 205.

In setting the metadata to indicate that the respective data asset 230 is to be protected, the tagging engine 245 may identify the data assets 230 that are to be protected. For each data asset 230 in the data asset storage 225, the tagging engine 245 may identify one or more attributes of the one or more files for the data asset 230, such as the residing location, the owner, the author or source, the file creation/update date and/or time, the file type, whether classified or sensitive data is included, file system permissions, among others. In some embodiments, the tagging engine 245 may consider or use the pre-existing or previously set meta-data (or tags) of the corresponding data asset 230. For example, the data asset 230 may have been downloaded from a source code repository and may have meta-data (or tags) indicating that the data asset 230 is source code. In this scenario, the tagging engine 245 may use the meta-data (sometimes referred to as meta tag) to control access or transfer of the data asset 230 (e.g., by identifying that the data asset 230 is to be protected) and may set or apply additional meta-data based on the usage of the data asset 230. The tagging engine 245 may determine whether any of the attributes matches one or more pre-specified attributes marked as to be protected. The pre-specified attributes may correlate to those attributes that are to be protected by the data access controller 235. In some embodiments, the pre-specified attributes may specify a combination of file attributes of the one or more files of data asset 230 to be protected. If any of the one or more attributes of the one or more files for the data asset 230 matches the pre-specified attributes, the tagging engine 245 may set the metadata of the corresponding data asset 230 to include the protection indicator. In some embodiments, the tagging engine 245 may store the meta-data for each data asset 230 of the data asset storage 225 onto the metadata storage 260. In some embodiments, the tagging engine 245 may store the file attributes of each data asset 230 along with the generated metadata onto the metadata storage 260.

In some embodiments, the tagging engine 245 may identify the residing location of the data asset 230. As discussed above, the residing location may be a file pathname that may indicate a drive letter, volume, server name, root directory, sub-directory, file name, and/or extension among others. The tagging engine 245 may determine whether the residing location corresponds to any of predefined list of protected locations. The predefined list of protected locations may also specify the level of protection that the location is to be treated. If the residing location corresponds to or meets the criteria of any of the predefined list of protection locations, the tagging engine 245 may set the meta-data of the data asset 230 to indicate that the data asset 230 is to be protected by inserting the protection indicator. Based on the specifications of the predefined list, the tagging engine 245 may set the level of protection for the protection indicator for the data asset 230. In some embodiments, the tagging engine 245 may parse the file pathname for the residing location of the one or more files for the data asset 230 to identify the drive letter, volume, server name, root directory, sub-directory, file name, and/or extension, among others. The tagging engine 245 may compare any one of the drive letter, volume, server name, root directory, sub-directory, file name, and/or extension to a location to be protected. The predefined list of protection locations may include file pathnames for the locations and may be specify any or more of the drive letter, volume, server name, root directory, sub-directory, file name, and/or extension. Upon determining a match between the parsed file pathname and any of the predefined list of protection locations, the tagging engine 245 may set the meta-data of the corresponding data asset 230 to include the protection indicator. In addition, based on the location to be protected, the tagging engine 245 may set the level of protection for the protection indicator for the data asset 230.

In some embodiments, the tagging engine 245 may identify the owner of the data asset 230. As discussed above, each data asset 230 may be associated with an owner indicated using a user identifier, such as a username, screenname, account identifier, or an electronic mail address. In some embodiments, the tagging engine 245 may compare the user identifier to a predefined list of protected owners (e.g., a user identifier corresponding to the administrator of the computing environment 205). The predefined list of protected owners may also indicate the level of protection to be set. If the user identifier for the data asset 230 matches any on the predefined list of protected owners, the tagging engine 245 may set the meta-data of the corresponding data asset 230 to include the protection indicator. Furthermore, the tagging engine 245 may set the level of protection for the protection indicator for the data asset 230 based on the specifications of the predefined list of protected owners.

In some embodiments, the tagging engine 245 may identify the file type of the one or more files for the data asset 230. The file type may be a document file, spreadsheet file, electronic emails, database file, image file, audio file, or video file, among others. In some embodiments, the tagging engine 245 may compare the file type to a predefined list of protected file types. The predefined list may also indicate the level of protection to be set. If the file type for the data asset 230 matches any on the predefined list of protected file types, the tagging engine 245 may set the metadata of the corresponding data asset 230 to include the protection indicator. Furthermore, the tagging engine 245 may set the level of protection for the protection indicator for the data asset 230 based on the specifications of the predefined list of protected file types.

In some embodiments, the tagging engine 245 may determine whether the data asset 230 includes classified or sensitive information. In some embodiments, the data asset 230 itself may have been marked as classified (e.g., “Top Secret”) or as containing sensitive information in the file attributes for the one or more files of the data asset. In some embodiments, the tagging engine 245 may parse the one or more files of the data asset 230 to identify the contained information. Having parsed the data asset 230, the tagging engine 245 may determine whether the contained information includes any on a predefined list of protected information. The predefined list may include one or more strings (e.g., in the form of words, identifiers or phrases) that correspond to protected information. The predefined list may also indicate the level of protection to be set. If the tagging engine 245 determines that the contained information includes any on the predefined list, the tagging engine 245 may set the metadata of the corresponding data asset 230 to include the protection indicator. Furthermore, the tagging engine 245 may set the level of protection for the protection indicator for the data asset 230 based on the specifications of the predefined list.

In some embodiments, the tagging engine 245 may identify the file system permissions specified for the data asset 230. As discussed previously, the file system permissions may specify whether the data assets 230 may be read, written to, or executed for each user and application 210. If any of the file system permissions for the data asset 230 is indicated as restricted, the tagging engine 245 may set the meta-data of the data asset 230 to include the protection indicator to indicate that the data asset 230 is to be protected. The tagging engine 245 may set the level of protection for the protection indicator based on which file system permissions are restricted. For example, if the write is to be restricted but read is to be permitted, the tagging engine 245 may set the level of protection to low. In contrast, if both the write and read are restricted, the tagging engine 245 may set the level of protection to high. In some embodiments, the tagging engine 245 may identify a number of file system permissions that are restricted for the one or more files of the data asset 230. Based on the number of file system permissions that are determined to be restricted, the tagging engine 245 may set the level of protection for the protection indicator in the meta-data of the data asset 230.

Having detected the capabilities of and activities within the computing environment 205 with respect to the data assets 230 of the data asset storage 225 identified to be protected, the learning engine 240 may determine a situation within the computing environment 205 that represent potential or actual exfiltration of the identified data assets 230. The learning engine 240 may determine the situation correlating to a potential or actual exfiltration of the identified data asset 230 using one or more machine learning techniques. In determining whether the situation corresponds to a potential or actual exfiltration of the identified data asset 230, the learning engine 240 may use a statistical prediction model, such as Bayesian networks, artificial neural networks, and support vector machines, among others. The statistical prediction model may use the capabilities of and activities within the computing environment 205 and the meta-data of the data assets 230 (e.g., protection indicator and level of prediction) to be protected, among other parameters, as inputs. The statistical prediction model may include one or more weights for the inputs to be applied. The statistical prediction model may have one or more layers (e.g., layers of axons in an artificial neural network or number of conditional probabilities in a Bayesian network). The statistical prediction model may output an indicator identifying whether the situation within the computing environment 205 represents a potential or actual exfiltration of the data asset 230. In some embodiments, the indicator may include a level of certainty identifying a likelihood that the situation within the computing environment 205 represents a potential or actual exfiltration of the data asset 230. The statistical prediction model may have been trained using training data from the training engine 250, as detailed below.

To train the learning engine 240 to identify the situations representing potential or actual exfiltration of data assets 230, the training engine 250 (e.g., source or storage for training data) of the data access controller 235 may provide training data for use by the learning engine 240. In some embodiments, the training data may be used by the learning engine 240 to recognize application or user behavior indicative or potential or actual data movement from the computing environment 205. In some embodiments, the training data may be received from another device (e.g., service provider of the data access controller 235). The training data may include situations predetermined to represent and/or not represent potential or actual exfiltration of data assets 230 from the computing environment 205.

In some embodiments, the training data may include, among other datasets: words or phrases on the GUI elements 215a-n of the application 205; user interactions with the GUI elements 215a-n; user interactions via the I/O control 123 with any of the devices connected thereto; API function calls 220a-n of the application 205; and/or any other routines/actions of the computing environment 205. In some embodiments, the training data may include, or be converted to one or more input values for use in training the statistical prediction model. Each of the one or more input values may be of any numerical data type, such as a Boolean, an integer, a double, and a floating value, among others. Training data can include a collection of input values, potentially or sometimes in groups to be delivered at specific time sequences relative to each other. Training data can also include the desired result the learning engine should produce given the input values. The desired result may include a specific action to be identified, and may include a risk level of the specific action being exfiltration and/or misuse for instance. Thus, the result included in the training input data can mark or identify the input values as representing potential or actual exfiltration/misuse of data assets or not. Hence, each of the datasets or entries of the training data may be marked/identified as positive correlating to situations representing potential or actual exfiltration/misuse of data assets 230, or as negative, correlating with situations not representing potential or actual exfiltration/misuse of data assets 230. The entries/datasets of the training data may be marked/identified with (or correspond to) a specific action to be identified (e.g., downloading the data asset 230 from a website, uploading to a website, copying to a remote server, sending to a printer, or any other activity that may be used to trigger an alert in a “live” environment, or be part of a set of forensic events for possible data misuse). In some embodiments, each of the datasets or entries may also include a weight indicating likelihood that the situation represents or does not represent potential or actual exfiltration/misuse of data assets 230. If the dataset or entry is marked as positive, the weight may be positive. If the dataset or entry is marked as negative, the weight may be negative.

The training engine 250 may feed or apply the training data to the statistical prediction model of the learning engine 240 for training. Feeding or applying the training data may modify or update the statistical prediction model of the learning engine 240. In some embodiments, there may be multiple training datasets. In some embodiments, there may be multiple statistical prediction models trained using one or more of the training datasets. In some embodiments, the training data provided by the training engine 250 may adjust the one or more weights of the statistical prediction model. In some embodiments, the training data provided by the training engine 250 may change or set the number of layers in the statistical prediction model. The learning engine may determine whether the statistical prediction model has completed or received a sufficient level of training. The determination of whether the statistical prediction model has completed or received a sufficient level of training may be based on whether an error measure of the statistical prediction model starts to exhibit concave behavior. Upon detection of such behavior, the learning engine may determine that the statistical prediction model has completed training and may stop feeding the training data to the statistical prediction model of the learning engine 240. In some embodiments, the learning engine may determine an accuracy of the statistical prediction model when trained with one or more training datasets. In some embodiments, the learning engine may use certain training dataset(s) to train the statistical prediction model and can use one or more other datasets to determine the accuracy of the statistical prediction model (e.g., if the statistical prediction model is trained to a sufficient level of accuracy). The learning engine may check the results of these datasets, for instance against known results of these datasets, to determine the accuracy of the statistical prediction model.

With the learning engine 240 having been trained, the learning engine 240 may use the detected capabilities of and activities within the computing environment 205 as inputs of the statistical prediction model. The learning engine 240 may also use the data asset 230 to be protected, or meta-data of the data asset 230, as inputs of the statistical prediction model. In some embodiments, the learning engine 240 may determine the situation within the computing environment 205 that represents potential or actual exfiltration/misuse of the identified data assets 230, responsive to a triggering event. The learning engine 240 may detect an occurrence of the triggering event. In some embodiments, the triggering event may include an expiration or start point of a predetermined time interval. In some embodiments, the triggering event may include detection of any activity within the computing environment 205, such as a user interaction with one of the GUI elements 215a-n, an invocation of an API function call 220a-n, a detection of activity at the I/O control 123, a detection of the installation/executable/presence of an application in the computing environment, a detection of use of the network interface 118, or any other routine (e.g., background services or threads) within the computing environment 205, among others. In some embodiments, the triggering event may include detection of a pre-specified activity within the computing environment 205. Having detected the occurrence of the triggering event, the learning engine 240 may apply the detected capabilities of and activities within the computing environment 205 and/or the data asset 230 or the meta-data of the data asset 230 as inputs of the statistical prediction model. In some embodiments, the learning engine 240 may access the meta-data storage 260 to identify the meta-data of the data asset 230 as input to the statistical prediction model.

For use with the statistical prediction model, the learning engine 240 may convert the detected capabilities of and/or activities within the computing environment 205 into an input value. In some embodiments, the learning engine 240 may convert the data asset 230 or the meta-data of the data asset 230 into an input value for use with the statistical prediction model. The input value may be of any numerical data type, such as a Boolean, an integer, a double, and a floating value, among others. In some embodiments, the input value may include one or more coordinate values with a multi-dimensional feature space. By applying the one or more input values to the statistical prediction model, the learning engine 240 may generate the output from the statistical prediction model. In some embodiments, the learning engine 240 may apply the one or more input values to the statistical prediction model, responsive to the triggering event. The learning engine 240 may in turn generate an output from the statistical prediction model.

By applying or feeding the inputs to the statistical prediction model, the learning engine 240 may generate the output indicating whether the situation within the computing environment 205 represent potential or actual exfiltration of the identified data assets 230. As explained above, the statistical prediction model may output an indicator identifying whether the situation within the computing environment 205 represents a potential or actual exfiltration of the data asset 230. The indicator may include the level of certainty identifying a likelihood that the situation within the computing environment 205 represents a potential or actual exfiltration/misuse of the data asset 230. In some embodiments, the indicator may include the level of certainty identifying a likelihood that the situation within the computing environment 205 represents a potential or actual misuse or exfiltration of data (e.g., movement, downloading, uploading, or storage at a restricted location, among others).

Using the situation determined by the learning engine 240, the rule engine 255 of the data access controller 235 may perform an action to prevent or control the potential or actual exfiltration of the one of the identified data assets 230. The action to prevent or control the potential or actual exfiltration of the identified data asset 230 may include, among others: warning the user against data movement of the identified data assets 230 (e.g., by displaying a prompt giving user option to permit or block exfiltration, or for alerting/prompting the user while allowing the potential or actual exfiltration to occur); permitting or blocking the application 210 from data movement of the identified data assets 230; permitting or blocking data movement of the identified data assets 230 via the I/O control 123; permitting or blocking data movement of the identified data asset 230 via the network interface 118; or any combination thereof.

The rule engine 255 may apply one or more rules to the determined situation on the computing environment 205 in determining the action to perform. Each rule may specify the action to perform based on the indicator generated by the statistical prediction model of the learning engine 240. In some embodiments, the rule may specify the action to perform based on the level of certainty identifying a likelihood that the situation within the computing environment 205 represents a potential or actual exfiltration of the data asset 230. In some embodiments, the rule may specify the action to be performed based on the meta-data of the data asset 230 to be protected. In some embodiments, for each action to be performed, the rules of the rule engine 255 may specify a combination of the indication generated by the statistical prediction model, a range of level of certainty generated by the statistical prediction model, and the meta-data of the data asset 230 identified to be protected, among others. For example, the rule may specify warning the user, if the level of protection in the meta-data of the data asset 230 is specified as classified (e.g., “top secret”) and the level of certainty that the situation is determined to represent a potential or actual exfiltration is 50-70%. The rule may also specify blocking the exfiltration of the data asset 230 and warning the user of the blocking, if the level of protection in the meta-data of the data asset 230 is specified as classified (e.g., “top secret”) and the level of certainty that the situation is determined to represent a potential or actual exfiltration (or data misuse) is greater than 70%. The rule may further specify displaying a prompt to the user giving user an option to block or permit, if the meta-data of the data asset 230 is specified as “public” and the level of certainty that the situation is determined to represent a potential or actual exfiltration is greater than 70%. Based on the specifications of the rule, the rule engine 255 may determine which action(s) to perform in preventing or controlling the data movement of the data assets 230 identified as to be protected. In this manner, the rule engine 255 may allow for flexibility in prevention and control in the risk arising from exfiltration of data assets 230.

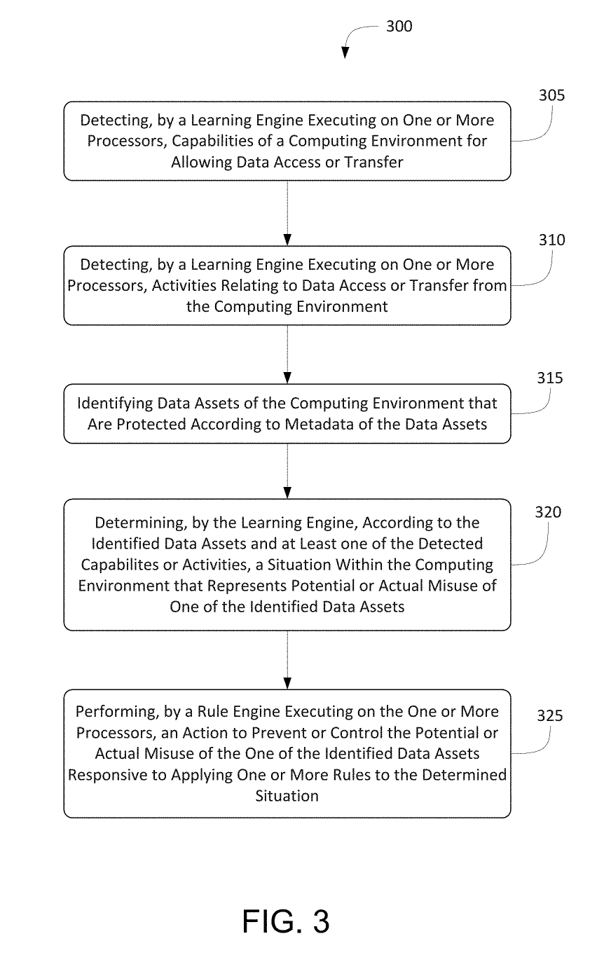

Referring now to FIG. 3, an embodiment of a method 300 for preventing or controlling data movement is depicted. The method 300 may performed or be executed by any one or more components of system 100 as described in conjunction with FIGS. 1A-1D or system 200 as described in conjunction with FIG. 2 such as the learning engine 240, the tagging engine 245, the training engine 250, and/or the rule engine 255 of the data access controller 235. In brief overview, the method 300 may include detecting, by a learning engine executing on one or more processors, capabilities of a computing environment for allowing data access or transfer (305). The method 300 may include detecting, by the learning engine, activities relating to data access or transfer from the computing environment (310). The method 300 may include identifying data assets of the computing environment that are protected, according to meta-data of the data assets (315). The method 300 may include determining, by the learning engine according to the identified data assets and at least one of the detected capabilities or activities, a situation within the computing environment that represents potential or actual exfiltration of one of the identified data assets (320). The method 300 may include performing, by a rule engine executing on the one or more processors, an action to prevent or control the potential or actual data movement of the one of the identified data assets, responsive to applying one or more rules to the determined situation (325).

Referring to (305), and in more detail, the method 300 may include detecting, by a learning engine executing on one or more processors, capabilities of a computing environment for allowing data access or transfer. In some embodiments, the learning engine 240 may identify capabilities of the application 210 in accessing the data asset storage 225 or transferring the data assets 230, over a predefined length of time for instance. In some embodiments, the learning engine 240 may identify the GUI elements 215a-n available to user control selection. The GUI elements 215a-n may be identified, for instance, using image recognition algorithms (e.g., image object recognition and optical character recognition) on a screenshot of the rendering of the application 210. In some embodiments, the learning engine 240 may identify API function calls 220a-n available for invocation by the application 210. The API function calls 220a-n may be identified using a predefined specification for the application 210.

Referring to (310), and in more detail, the method 300 may include detecting, by the learning engine, activities relating to data access or transfer to, from, or through the computing environment. In some embodiments, the learning engine 240 may detect the activities by the application 205 in relation to access of the data asset storage 225 or transfer of the data assets 230. In some embodiments, the learning engine 240 may monitor for or detect user interactions with the GUI elements 215a-n, over a length of time for instance (which may be the same as or different from, and/or coincide with the predefined length of time for identifying capabilities of the application 21). The user interactions with the GUI elements 215a-n may be detected using, for instance, listening/intercepting/hooking techniques for detecting such interactions, and/or image recognition algorithms (e.g., image object recognition, optical character recognition, and motion detection) on multiple screenshots of the rendering of the application 210. The learning engine 240 may monitor for or detect invocations of API function calls 220a-n. The API function calls 220a-n may be detected using hooking techniques (e.g., insertion of a hooking function into the function call 220a-n, DLL injection, import address table hooking). In some embodiments, the learning engine 240 may monitor or detect use of the I/O control 123. In some embodiments, the learning engine 240 may monitor or detect use of the network interface 118. In some embodiments, the learning engine 240 may interrelate among the various activities and/or capabilities relating to data access or transfer from the computing environment 205. The learning engine 240 may interrelate among the various activities and/or capabilities according to data assets identified to be protected.

Referring to (315), and in more detail, the method 300 may include identifying data assets of the computing environment that are protected, according to meta-data of the data assets. In some embodiments, a tagging engine 245 or another component in the computing environment 205 may set the meta-data of the data asset 230. For each data asset 230 in the data asset storage 225, the tagging engine 245 may identify one or more attributes of the one or more files for the data asset 230, such as the residing location, the owner, source/author, date/time of update or creation, the file type, whether classified or sensitive data is include, file system permissions, among others. In some embodiments, the tagging engine 245 may set the meta-data of the data asset 230 to include the protection indicator. The protection indicator may specify whether the accessing and transfer of the data asset 230 is to be protected by the data access controller 235. In some embodiments, the protection indicator may also specify a level of protection for the data asset 230.

Referring to (320), and in more detail, the method 300 may include determining, by the learning engine according to the identified data assets and at least one of the detected capabilities or activities, a situation within the computing environment that represents potential or actual exfiltration of one of the identified data assets. In some embodiments, the learning engine 240 may determine the situation correlating to a potential or actual exfiltration of the identified data asset 230 using a statistical prediction model, such as Bayesian networks, artificial neural networks, and support vector machines, among others. The statistical prediction model may use the capabilities of and activities within the computing environment 205, and/or the meta-data of the data assets 230 (e.g., protection indicator and level of prediction) to be protected, among other parameters, as inputs. The statistical prediction model may include one or more weights for the inputs to be applied. The statistical prediction model may have one or more layers (e.g., layers of axons in an artificial neural network or number of conditional probabilities in a Bayesian network). The statistical prediction model may output an indicator identifying whether the situation within the computing environment 205 represents a potential or actual exfiltration of the data asset 230. In some embodiments, the indicator may include a level of certainty identifying a likelihood that the situation within the computing environment 205 represents a potential or actual exfiltration of the data asset 230. The statistical prediction model may have been trained using training data from the training engine 250.

Referring to (325), and in more detail, the method 300 may include performing, by a rule engine executing on the one or more processors, an action to prevent or control the potential or actual data exfiltration/misuse of the one of the identified data assets, responsive to applying one or more rules to the determined situation. The action to prevent or control the potential or actual exfiltration/misuse of the identified data asset 230 may include, among others: warning the user against data exfiltration/misuse of the identified data assets 230 (e.g., by displaying a prompt giving user option to permit or block exfiltration/misuse, or a notification while the potential or actual data exfiltration is allowed to proceed); permitting or blocking the application 210 from data exfiltration/misuse of the identified data assets 230; permitting or blocking data exfiltration/misuse of the identified data assets 230 via the I/O control 123; permitting or block data exfiltration/misuse of the identified data asset 230 via the network interface 118; or any combination thereof. In some embodiments, the rule engine 255 may apply one or more rules to the determined situation on the computing environment 205 in determining the action to perform. Each rule may specify the action to perform based on the indicator and/or the level of certainty determined by the statistical prediction model of the learning engine 240.

The description herein including modules emphasizes the structural independence of the aspects of the controller, and illustrates one grouping of operations and responsibilities of the controller. Other groupings that execute similar overall operations are understood within the scope of the present application. Modules may be implemented in hardware and/or as computer instructions on a non-transient computer readable storage medium, and modules may be distributed across various hardware or computer based components.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

Example and non-limiting module implementation elements include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

Non-limiting examples of various embodiments are disclosed herein. Features from one embodiments disclosed herein may be combined with features of another embodiment disclosed herein as someone of ordinary skill in the art would understand.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that, unless otherwise noted, any parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

What is claimed is:

1. A system for preventing or controlling misuse of data, the system comprising:
a learning engine executing on one or more processors, the learning engine configured to:
detect capabilities of a computing environment for allowing data access or transfer, and activities relating to data access or transfer from, into or through the computing environment; and
determine, according to data assets of the computing environment that are identified to be protected, and at least one of the detected capabilities or activities, a situation within the computing environment that represents potential or actual misuse of one of the identified data assets, wherein the data assets that are to be protected are identified according to metadata of the data assets; and
a rule engine executing on the one or more processors, the rule engine configured to perform an action to prevent or control the potential or actual misuse of the one of the identified data assets, responsive to applying one or more rules to the determined situation.

2. The system of claim 1, further comprising training data for use by the learning engine to recognize application or user behavior indicative of potential or actual misuse of data.

3. The system of claim 1, wherein the learning engine is configured to detect the capabilities or the activities by monitoring or detecting one or more of: graphical user interface (GUI) controls available to a user control selection by the user, application programming interface (API) calls, files accessed, data communicated over a network, or activity using an input/output (I/O) device.

4. The system of claim 1, wherein the learning engine is configured to identify a first data asset that is protected, by monitoring or identifying at least one of: a residing location of the first data asset, an owner of the first data asset, a type of the first data asset, or whether part or all of the first data asset comprises classified or sensitive data.

5. The system of claim 1, wherein the computing environment comprises at least one of a web browser, an application, background system service, or an input/output (I/O) device.

6. The system of claim 5, wherein the application comprises a cloud-synchronization application, an electronic-mail application, a document processing or rendering application, a data transfer or copying application, or a facsimile or printing application.

7. The system of claim 1, wherein the learning engine is configured to detect the capabilities or the activities by detecting meta-data, words or phrases associated with application interfaces indicative of means of data egress from the computing environment.

8. The system of claim 7, wherein the learning engine is configured to determine the situation within the computing environment that represents potential or actual misuse of the one of the identified data assets, by relating the detected words or phrases in the application interfaces, to an user action via one or more corresponding application interfaces.

9. The system of claim 1, wherein the learning engine is configured to determine whether there is a situation within the computing environment that represents potential or actual exfiltration of one or more of the identified data assets, responsive to a triggering event.

10. The system of claim 1, wherein the action to prevent or control the potential or actual misuse of data comprises at least one of: warning or blocking a user against data movement of the one of the identified data assets, or blocking data movement of the one of the identified data assets by an application.

11. A method for preventing or controlling misuse of data, the method comprising:
detecting, by a learning engine executing on one or more processors, capabilities of a computing environment for allowing data access or transfer, and activities relating to data access or transfer from the computing environment;
identifying data assets of the computing environment that are protected, according to metadata of the data assets;
determining, by the learning engine according to the identified data assets and at least one of the detected capabilities or activities, a situation within the computing environment that represents potential or actual misuse of one of the identified data assets; and
performing, by a rule engine executing on the one or more processors, an action to prevent or control the potential or actual misuse of the one of the identified data assets, responsive to applying one or more rules to the determined situation.

12. The method of claim 11, further comprising providing the training data, for use by the learning engine to recognize application or user behavior indicative of potential or actual misuse of data.

13. The method of claim 11, wherein detecting the capabilities or the activities comprises monitoring or detecting one or more of: graphical user interface (GUI) controls available to a user, control selection by the user, application programming interface (API) calls, files accessed, data communicated over a network, or activity using an input/output (I/O) device.

14. The method of claim 11, further comprising identifying a first data asset that is protected, by monitoring or identifying at least one of: a residing location of the first data asset, an owner of the first data asset, a type of the first data asset, or whether part or all of the first data asset comprises classified or sensitive data.

15. The method of claim 11, wherein the computing environment comprises at least one of a web browser, an application, background system service or an input/output (I/O) device.

16. The method of claim 15, wherein the application comprises a cloud-synchronization application, an electronic-mail application, a document processing or rendering application, a data transfer or copying application, or a facsimile or printing application.

17. The method of claim 11, wherein detecting the capabilities or the activities comprises detecting words or phrases in application interfaces indicative of means of data egress from the computing environment.

18. The method of claim 17, wherein determining the situation within the computing environment that represents potential or actual misuse of the one of the identified data assets, comprises relating the detected words or phrases in the application interfaces, to a user action via one or more corresponding application interfaces.

19. The method of claim 11, further comprising determining whether there is a situation within the computing environment that represents potential or actual exfiltration of one or more of the identified data assets, responsive to a triggering event.

20. The method of claim 11, wherein the action to prevent or control the potential or actual misuse of data comprises at least one of: warning or blocking a user against data movement of the one of the identified data assets, or blocking data movement of the one of the identified data assets by an application.
